(19) United States
(12) Patent Application Publication
(10) Pub. No.: US 2006/0031830 A1
(43) Pub. Date: Feb. 9, 2006

(54) System with location-sensitive software installation method

(75) Inventors: Simon Chu, Chapel Hill, NC (US); Richard Alan Dayan, Raleigh, NC (US); Jeffery Bart Jennings, Raleigh, NC (US); David B. Rhoades, Raleigh, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/910,020

(22) Filed: Aug. 3, 2004

(51) Int. Cl. G06F 9/445

(52) U.S. Cl. 717/174

(57) ABSTRACT

A method, system, and operating system (OS) software utility that prevents installation of a software product in a computer system in an un-approved location. The OS of the computer system (or the application itself) is coded to require a check of geographical restrictions prior to installing certain software products. The computer system is provided with a GPS receiver, which provides current geographic or spatial location of the computer system. When application installation is requested, the current location is compared against a list of approved locations for installing software on the computer system. No software installation is allowed on the computer system unless the current location is an approved location for the software and/or the computer system.

### BACKGROUND OF THE INVENTION

1. Technical Field

The present invention relates generally to computer software and specifically to installation of computer software on a computer system. Still more particularly, the present invention relates to a method, system, and operating system (OS) program product for enforcing location based restrictions of software installations on a computer system.

2. Description of the Related Art

Certain software products used in computer systems are subject to some type of export/import restrictions. For example, a software package offering bulk data encryption manufactured in the United States of America (U.S.A) can only be exported to certain countries. Thus, U.S.A. manufacturers may only export a 56 bit encryption algorithm outside of US borders.

In order to enforce/control restrictions on software, governmental entities, such as the United States Commerce Department, often specify what export restrictions are placed on the software (or technology). From a governmental standpoint, these restrictions may be based on some determination that the particular software is vital to national advancement in certain technological areas (such as military applications), maintaining national security, and/or beneficial to advancement of U.S. economy. Tied to these factors is a concern that certain technologies, if expected, may fall into the wrong hands and be utilized in undesirable ways that may negatively impact the economy, security, or prestige of the United States of America.

In addition to the government-imposed restrictions, certain private companies also place restrictions on the use of proprietary software (or portable computer system) outside of certain predefined geographic or other boundaries, e.g., specific company sites with added security. These private companies often provide high-end security access to the software/computer system and, in some instances, may actually delete software prior to the computer system leaving the secure facility. Control of the use of such software and computer systems may also entail restrictions on when/where software may be installed on a computer system.

Despite the need for control of where the software may be installed on the computer system, most software products are made available for purchase. Even the highly protected proprietary software of a private company (or government) may be sold by unscrupulous employees or hackers to the highest bidder (e.g., on the black market). Traditionally, once software is made available to a user, there was no way to restrict how/when the software was installed into the computer system and used. Unauthorized installation and use of the software could thus not be controlled. Likewise, when a computer system (e.g., a laptop) is assigned to a user (such as an employee), the employer/owner of the computer system finds it difficult to control what software is installed on the system and where that software installation takes place.

One major development over the past years has been the development/implementation of location devices. These location devices include global positioning system (GPS) receiver/transmitter components installed within a computer system, which enables general use of GPS technology. Several recent patent applications have been submitted covering the use of GPS technology to provide some levels of control with respect to software use on a computer system. Most of these applications provide features related to restricting use of installed software applications to specific locations identified using GPS technology. However, once installed, the integrity (security features) of the software may be compromised by a software hacker.

While the use of GPS and other location systems to enable/disable features of an installed software component is provided, there is no teaching in the art that recognizes or addresses the problem of illegal or unauthorized installation of the software in the first place. Further, the control with respect to the software is, in most instances, handled by a remote server and is not a direct functionality of the software.

The present invention recognizes that it would be beneficial to provide a software-controlled, autonomic process for preventing installation of software in a computer system at a location not authorized for such an installation. This and other benefits are provided by the invention described herein.

### SUMMARY OF THE INVENTION

Disclosed is a method, system, and operating system (OS) software utility that prevents software/application installation in a computer system located within an un-approved location (geographic/spatial). The OS of the computer system is coded to require a check of geographical/location-based restrictions prior to installing certain software products. The computer system is provided with a location device, such as a low-end GPS receiver, linked to the BIOS and the OS of the computing system. The location device provides current geographic or spatial location of the computer system.

In the illustrative embodiment, the owner of a computer system may restrict certain applications from being installed on the computer system outside of a controlled area. The owner thus specifies which software applications are restricted from installation and which locations the restrictions apply to. Another user is thus restricted from utilizing the computer system to install certain software outside of pre-specified approval locations.

In one embodiment, the location-based restrictions on installation are provided as a location approval utility that is separate/independent from the OS and the software application. The utility is provided as a separate component of the OS or an add-on OS utility that includes user-interfacing features.

In one embodiment, software application subject to installation restrictions is provided a location-restricted installation identifier (LRIID) within the installation/executable portion of the program code. The LRIID points to a table of approved locations and/or a server IP address that must be accessed prior to installation of the software. When the user attempts to install the software, the OS runs the installation code (executable component of the program application) and reads the LRIID. The OS is automatically signaled that installation may only proceed if the location checks are completed and the current location is approved. The OS retrieves the current location of the computer system (from the GPS receiver or register, etc.) and initiates a check for approval of the current location.

If the LRIID indicates there is a list of approved locations within the application code, the BIOS retrieves only that portion of the application code and checks the current location with the pre-approved list of locations. Alternatively, an LRIID may signal a required access to the LRIID server on an accessible network (global/WAN or LAN). Once the list of pre-approved locations is available, the OS compares the current location against the pre-approved list of locations. When the value matches (or falls within a range of) one of the pre-approval locations, the installation of the software is allowed to complete.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of a laptop, representing a portable computer device, within which the features of the present invention may advantageously be implemented;

FIG. 2 is a block diagram of an exemplary GPS subsystem of the computer device of FIG. 1, according to one embodiment of the invention;

FIG. 3A illustrates a computer network with an LRIID server accessed by the computer system during one implementation of the invention;

FIG. 3B is a GPS based global network utilized for identifying a geographic location of a portable device according to one embodiment of the invention;

FIG. 4 is a flow chart depicting the process of installing software on a computer system with location-based restrictions on installation according to one embodiment of the invention;

FIG. 5 illustrates an exemplary makeup of the executable portion of application code within a readable computer medium according to one embodiment of the invention; and

FIG. 6 is a series of block representation of the functionality provided by the computer system and the server according to one embodiment of the present invention.

### DETAILED DESCRIPTION OF AN ILLUSTRATIVE EMBODIMENT

The present invention provides a method, system, and operating system (OS) software utility that prevents installation of a software product in a computer system in an un-approved location. The OS of the computer system (or the application itself) is coded to require a check of geographical restrictions prior to installing certain software products. The computer system is provided with a location device, such as a low-end GPS receiver, linked to the BIOS and the OS of the computing system. The location device provides current geographic or spatial location of the computer system. When application installation is requested, the current location is compared against a list of approved locations for installing software on the computer system. Once the list of pre-approved location is available, the OS compares the current location against the pre-approved list of locations. When the value matches (or falls within a range of) one of the pre-established locations, the installation of the software is allowed to complete. No software installation is allowed on the computer system unless the current location is approved for the software and/or the computer system.

The invention is described with specific reference and description of a generic portable computer system, which is capable of installing and executing software that may, according to the invention, be subject to software installation restrictions or other location-based restriction. Thus, the computer system may be a laptop computer, desktop computer, handheld computer, or even a cellular phone, etc.

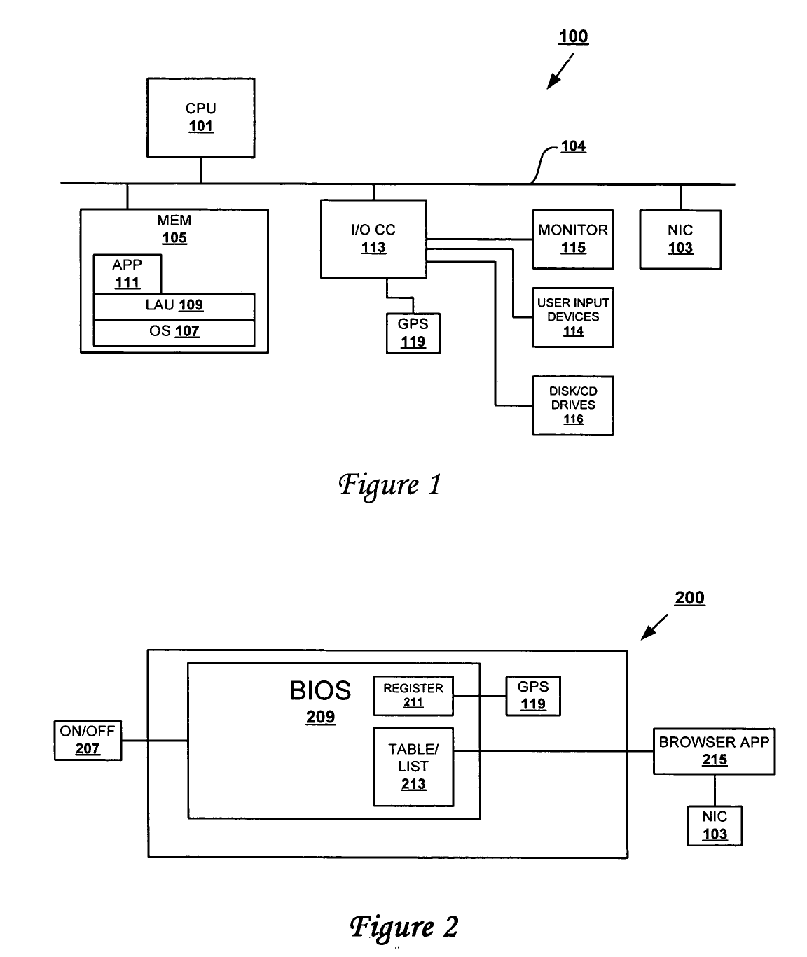

With reference now to the Figures and in particular to FIG. 1, there are illustrated hardware (and software) components of an exemplary computer system. Computer system 100, comprises a processor (CPU) 101, which is coupled via a system bus 104 to a memory 105, input/output controller (I/OCC) 113, and network interface controller (NIC) 103. NIC 103 is utilized to connect computer system 100 to external networks, such as the Internet. Coupled to I/OCC 113 are monitor 115, user input devices (mouse, keyboard, etc.) 114, input drives (disk and/or CD drives, etc.) 116. Also coupled to I/OCC 113 are GPS sensor/receiver (location devices) 119. GPS receiver 119 is utilized for receiving GPS data about current location of computer system 100, as described in greater details below.

Stored within memory 105 is operating system (OS) 107 which executes on the processor 101 and controls basic operations of the computer system, including installation of new software. According to one implementation of the invention, memory 105 also includes location approval utility (LAU) 109, by which the location retrieval, location comparison, server access, and approval/denial of software installation, and other related features of the invention (e.g., disabling of installed software application) are provided. Location approval utility 109 may be loaded on the computer system utilizing input drives 116 or downloaded from the Internet 301 via NIC 103.

According to one embodiment of the invention, restrictions on installation are actually provided as a utility that is separate/independent from the software application and the OS. The owner of a computer system may wish to restrict certain applications from being installed on the computer system outside of a controlled area. A location approval utility is provided as a separate component from the OS or an add-on utility that includes user-interfacing features. In one implementation, the location approval utility is packaged as an add-on to the computer system software (OS and/or applications). In another embodiment, the location approval utility is independently downloaded from the web site of a location approval server into the computer system when the computer system is connected to the Internet and installation software is initiated.

Utilizing features provided by this utility, the owner of the computer (or software developer) is able to specify which software applications are restricted from installation and which locations the restrictions apply to. A user is thus restricted from utilizing the computer system to install certain specific software outside of specified locations.

FIG. 2 illustrates an exemplary locator (GPS) subsystem of the computer system of FIG. 1. Locator subsystem 200 comprises several components of computer system 100, specific to the functional operation of the invention. As illustrated, locator subsystem (LS) 200 comprises a power on/off button 207, utilized to power the computer system on and off. LS 200 also comprises a basic input output system (BIOS) 209, which performs a power on self test (POST) operation when computer system 100 is first turned on, and a GPS receiver 119, utilized to receive current coordinates of the computer system. BIOS 209 includes a location register 211 which stores the current location received by GPS receiver 119 from the GPS network. In one implementation, that location is stored within a register and automatically updated as the location changes.

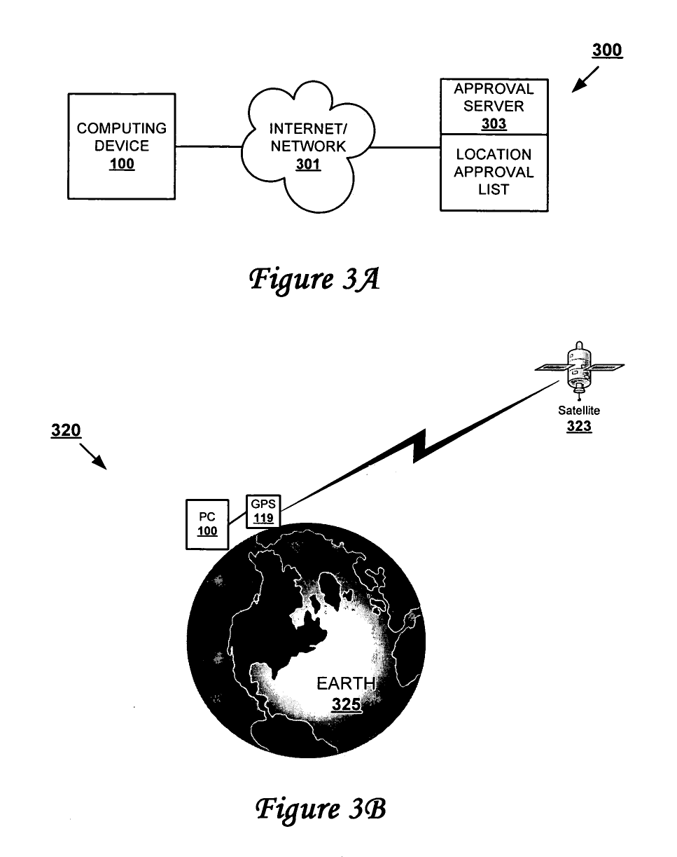

FIG. 3B illustrates a GPS network 320 in which the GPS receiver 119 of computer system 100 receives current location data from a satellite 323 orbiting the earth 325. In one embodiment, this GPS receiver is a component of the computer system. The invention also contemplates an embodiment in which the GPS receiver (or similar functionality) is integrated into the CD-ROM/disk (or casing) on which the software application is written, such that the software is actually able to provide its own “current location” data. This embodiment removes the requirement that a GPS receiver or other location device be a physical component of the computer system.

Other tracking systems may involve connecting the computer system to a local or global network, such as a LAN or the Internet, respectively. The addresses (LAN or IP address) or signature of the computer device along with that of the server at which the device connects to the network are utilized to deduce the location of the device. Thus, one alternative method of providing location information is by utilizing an existing network, such as the Internet and known locations of gateway servers to the network. The computer system's location may then be identified with the location of the gateway server (or port) to which the computer system initiates a connection to the network. The port is determined when the computer system connects to the phone/DSL/ISDN or LAN or Wireless LAN, etc., at the current location.

The invention prevents unauthorized installation of software programs/code (or program applications) on computer systems that are not in approved/authorized physical locations (spatial or geographic). In the illustrative embodiment, the invention implements a security policy manager within (or associated with) the OS. The security features are user programmable and are protected by a password or other security mechanism. Thus, a system owner or administrator is able to establish location-specific security policy for a client computer (e.g., and employee's computer).

FIG. 3A illustrates a network 300 having the computer system 100 connected to a location approval server 303 via the Internet 301. While illustrated as the Internet 301, the network is not limited in scope to the Internet and may be any LAN or WAN that supports remote access by the computer system. In one embodiment, server 303 comprises a table in which the list of location-restricted software for a corresponding computer system is stored for download on to the computer system 100, whenever the computer system connects to the Internet from outside of a secure environment. The table may be created and periodically updated by the owner of the computer system, who wishes to monitor/control/restrict installation of applications on the computer system outside of a controlled environment.

In the illustrative embodiment, the location approval (or permission) list is maintained at the location approval server, which is accessible to the computer system. In an alternate embodiment, the permission list is maintained within the computer system by location approval utility and/or coded segments of the application desired to be installed. Returning to the illustrative embodiment, depending on the security sensitivity indicated in the application or device driver and age of the permission list, the client computer system may contact an authorized server for a more current permission list. A special network-connection software agent/layer is provided on the computer system that is triggered to establish a connection to the location approval server.

The location approval server is administered by an administrator. The server specifies the GPS coordinate zone(s) (via the permission list) in which specific software may be installed in a particular computer. The location approval/permissions may be unique for each software package and/or for each computer system. Thus, in a first implementation, a separate list is maintained for each application and/or for each computer system that is subject to a location-based restriction (for software installation). In the implementation where the computer system is location-restricted, however, a single list maybe utilized to control all installation of software application on that computer system. The present illustration and description of a client-server setup provides only one or several embodiments that allows for a dynamic environment.

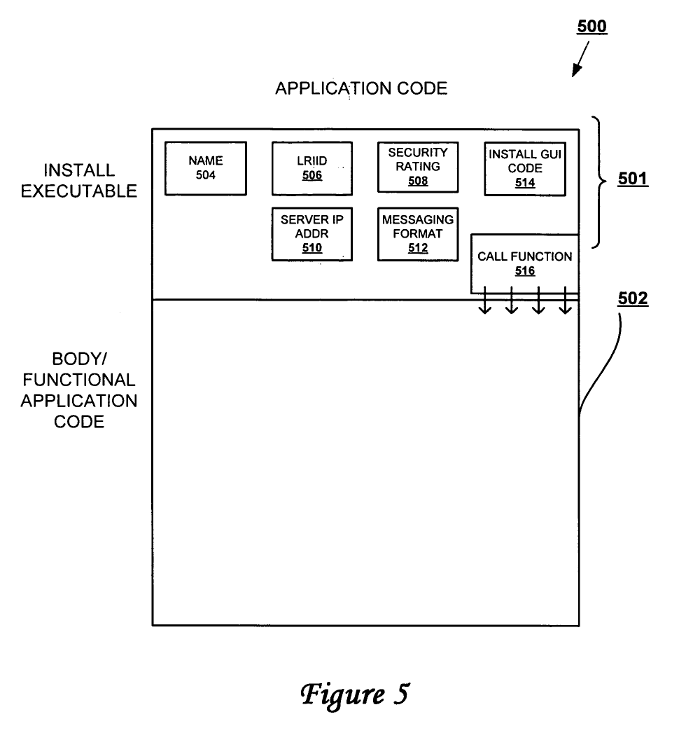

In the embodiment that provides a software-focused location-restriction, software application that is subject to installation restrictions based on location is “tagged” within the installation portion of the program code with a location-restricted installation identifier (LRIID). FIG. 5 illustrates exemplary software modules that make up a program application 500. As shown, program application 500 comprises two main parts, a header portion 501 and a body portion 502. The body portion 502 is the functional application code that actually provides the functional features of the application, when executed. The header portion comprises various modules/fields, including application name 504, installation GUI segment 514 and associated call functions 516, which together provide the installation components of the application. Additionally, header portion 501 is extended to include two security fields, LRIID 506 and associated security rating 508. Finally, header portion 501 also comprises server IP address field 510 and messaging format field 512. No particular order is attributed to the modules/fields in the header portion 501, and the layout and description provided are meant solely for illustration and not meant to confer any structural limitations on the invention. The functionality attributable to each of the new/extended fields is described below.

The LRIID is provided by the software developer. Alternatively, in one implementation methods are provided for inserting the LRIID and other relevant fields post-development of the software application. The LRIID points the installation process to a list of approved locations and/or a server IP address that must be accessed prior to installation of the software.

When the user attempts to install the software, the OS runs the installation code (executable component of the program application) and reads the LRIID. The OS is automatically signaled that installation may only proceed if the location checks are completed and the location is approved. The OS retrieves the current location of the computer system (from the GPS receiver or register, etc.) and initiates a location check utility in the background.

If the LRIID indicates a coded approved location list within the application code, the OS retrieves only that portion of the application code and checks the current location with the pre-approved list of locations. Alternatively, the LRIID may signal a required access to an LRIID server on an accessible network (globaVWAN or LAN). With this implementation, the user may be provided with a signal (pop up window) indicating that the installation requires a prior access to a remote server via a network connection. This signal may not be required if the computer system is already connected to the Internet/network. However, there may be some additional security mechanism in place that would require the user to enter a password to actually gain access to the remote server to enable the installation.

The security rating 508 is a construct provided to allow different levels of installation permissions for different applications or at different locations. The security level may be visualized to be a weighted need for security with respect to installation of the application. For example, a graduated level (0-15) may be pre-defined, where 0 is the lowest security level and 15 is the highest. Thus, during the installation checks for location approval, if level=0, indicating there is no restriction on installation of the application, the application may be installed anywhere. However, if level=15, the application may only be installed in a specific location accompanied by some near infallible security measure such as a successful retina scan or fingerprint. Standard specific location approval may be identified for level 8, with country-wide (continental USA) approval for level 4, and password required approval for level 10, and so on. In one such implementation, level 10 or higher may require third party approval, such as permission from an authorized server. The specific levels and range of levels provided above are for illustration only and not meant to be restrictive on the invention.

In one embodiment, software is written that takes direct advantage of the zone information on the server. The software autonomically queries the server whether installation is possible based on the positional coordinates sent to the server. These coordinates are retrieved from the GPS receiver and placed in the query that is sent to the server. The server is programmed to read and respond to such queries after examining a comprehensive list of approved locations for that specific software. Accordingly, the server may be provided by a service provider as a service to software developers who wish to restrict the locations in which multiple, different software may be installed. The service provider maintains the server and provides the software developers with the IP address 510 for transmitting the queries as well as designate the particular messaging/communication protocol 512 to be utilized when generating the queries. The IP address is then coded into the installation code for the application, and the queries are generated according to the message format specified by the service provider and sent to the IP address identified therein.

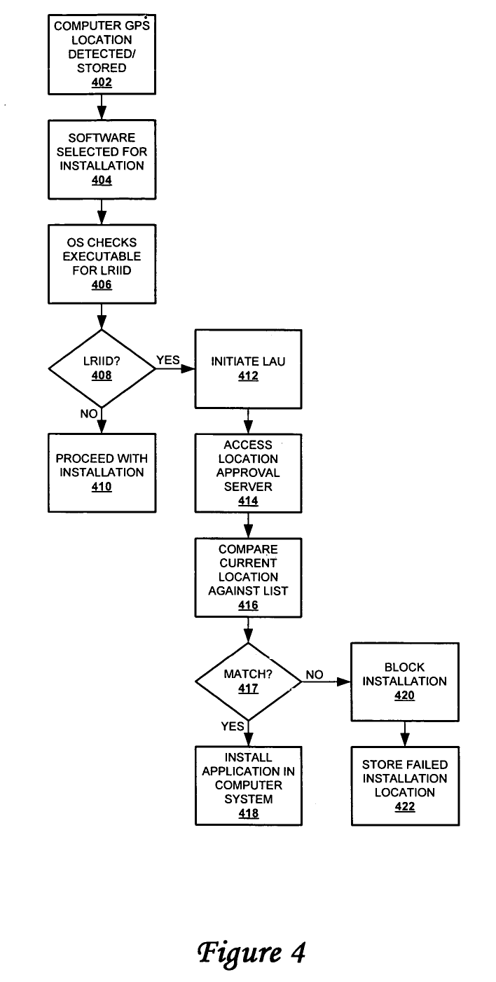

FIG. 4 provides a flow chart of the process of installing software on a computer system according to the location restrictions provided by the invention. As described above, the computer system is manufactured with or enhanced with a location device, such as a low-end GPS device, linked to the BIOS and the OS of the computer system. The location device (hereinafter GPS receiver) detects and stores the present geographic location (GPS coordinates) of the computer system in the location register as indicated at block 402. Notably, this list may be a set of geographic coordinates or the actual name of the location. The exact form in which the information is presented and check is not limiting on the invention. When coordinates are utilized, however, the checking involves mapping the current value within a range of values and is thus more cumbersome to execute.

Returning to FIG. 4, the OS installation tool monitors user activity and determines at step 404 whether an application installation is initiated. Initiating may be an automatic trigger when the medium (disk, etc.) on which the application is distributed is inserted in to the computer system. Alternatively, the user may select the executable file (e.g., run.exe, or setup-exe) to initiate installation. When an application installation process is launched, the OS of the computer system retrieves the installation zone (IZone) data from the location register at step 406 to determine what zone or zones the computer system is presently located in. The installation module of the OS examines the application's header for presence of the new security fields at step 408. When present, these security fields (the LRIID or combination of the LRIID and security level) indicate whether there are location restrictions on the installation. If there are no security fields, then the software is installed as a normal installation at step 410. However, if there is a security field, the OS is trigger to initiate a location approval utility at step 412. The location approval utility accesses the location approval server at step 414 for the list of approved locations.

The current location is then compared, at step 416, to the approval/permission list and the pre-configured security policy to determine if installation of the software is permitted at that location of the computer system. Notably, for extremely sensitive technology with extensive restrictions, the verification may simply compare the present location against a short list of approved locations, rather than checking against the un-approved locations for installing the software.

If installation is permitted, the application is loaded into memory and then installed in the standard manner as shown at step 418. However, if the installation is not permitted, installation is blocked at step 420, and a security record is logged in a special log file at step 422. In one embodiment, an alert (if pre-configured) is sent to a pre-designated server (at step 422). The system administrator is thus alerted of the attempts by the user to install software in an unauthorized/unapproved location. The processes completed within the various blocks described in FIG. 4 are executed by the processor of the computer system described in FIG. 1 above.

In one related implementation, a monitoring feature is provided with the software and allows the software to register the locations in which attempts are made to install the software. During subsequent access to the server, information about these locations may be provided to the server. This enables the government or software manufacturer (or owner of the computer system) to track the attempts to install the software in restricted locations.

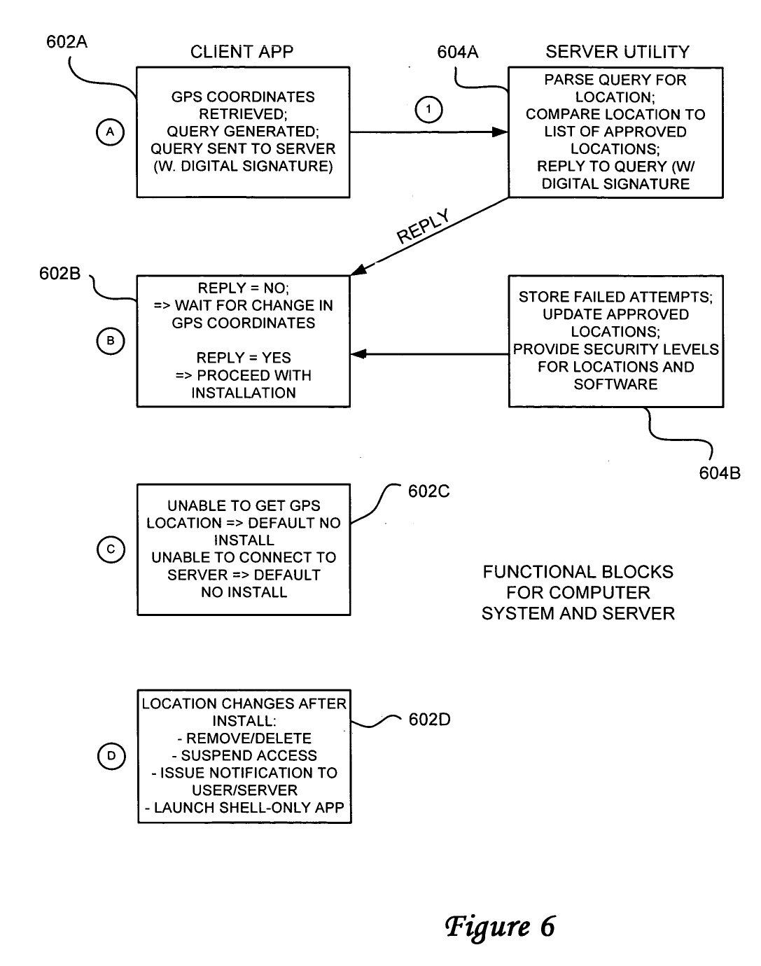

FIG. 6 provides a series of blocks within which functional features of the location approval utility within the computer system and the associated utility within the location approval server are illustrated. Arrows represent interaction between the two components, which refer specifically to a query for installation approval and response to the query. Blocks A-D of location approval utility 602A summarizes the above described operations at the computer system. Blocks A-D of server utility 604A summarizes the above server-implemented operations.

In one embodiment, illustrated within blocks 602A and 604A, the computer system and server digitally sign the request and response to insure that the contents are not tampered or spoofed. Also, as indicated at block 602B, location approval utility tracks the response received from the server utility in block 604A, which reply message is either “yes proceed with install” or “no terminate/suspend installation”.

Block 602C illustrates the use of default settings within the processes described above. If the computer system is not able to access the server, the default provided to the OS is not to install the application. In one embodiment, this default may optional be setup as a security policy that is a configurable item based upon its priority. Also, when (or if) the GPS receiver cannot determine the current location, the default provided to the OS is not to install the application. This default is required in the event a “jammer” is utilized to attempt to override the security protection provided by the present invention. The default feature may also be provided within the multi-level security policy described above, and changes based on the specific security level defined for the application or computer system. The processes completed within the various blocks described in FIG. 6 may be executed by the processor of the computer system described in FIG. 1 above.

Because a computer with installed software may later be moved to a location in which the software is not approved for installation or utilization, the invention further provides a series of back-end security mechanisms for addressing already installed components. Several of these mechanism may be similar to existing password protect security features or disabling of software application based on the current location. Thus, when the current location is not approved, the OS may provide one or more of the following response: (1) notifying the user of potential violation, (2) disabling the software for a temporary duration with an ability to re-enable, (3) automatically un-installing the software from the computer system; and/or (4) launching a shell version of the software, whereby specific features are restricted from access to the user. Co-pending patent application, (Docket No. RPS920030112US1; Application Ser. No. ______), filed on DATE, 2003 and assigned to the same assignee, describes measures for protecting (enabling, disabling, etc.) software subject to import/export restricted software. The relevant content of that application is hereby incorporated by reference.

In one embodiment, the OS also tracks (i.e., maintains a list/table of) those software applications that were location-restricted for installation and occasionally monitors a current location to see if the computer device is moved outside of a pre-approved location. While the pre-approved location for installation may not necessarily affect later access to the software, the invention implements additional security measures that may be connected to execution of the installed software, where required. These methods/measures may extend currently existing security methods or provide new methods. In one embodiment, the entire software is disabled or deleted from the memory of the computer system or hidden within the visible execution paths of the computer system.

Since the invention is primarily focused on preventing installation of the actual software in the first place, the invention provides a back-end security mechanism that visually and functionally removes the application from access by or to the user of the computer system. Accordingly, the application's executables are dynamically removed from the OS execution, and the application is not displayed within the list of available applications in the menu of applications/files. A user is thus forced to re-install the application for use at the specific location and go through a series of security checks required for installation at that location, if installation is available. One method requires only the execution of the location approval utility portion of the installation process. Once the location receives approval, the previously installed version of the application is made functionally and visually available to the user.

Because the list of restricted software and associated restricted locations may change after the software is bought and/or loaded on the computer system, the invention provides an automatic server access feature by which the OS dynamically initiates access to the Internet and goes to the location approval server for an updated list of approved locations.

The invention provides several definable benefits, including: (1) allowing for trusted software installation; (2) reducing the concern about unlicensed software being installed. That is, the install program may also be execution restricted with this method; (3) allowing for laptop users to only install authorized applications at home; and (4) allowing for very specific adherence to licenses of the software. For example, the administrator specifies a building/room as an installation zone for licensed/proprietary software, and the software is not able to be installed in any other buildings/locations.

The invention further allows for system recovery in case of theft. That is, if the computer is removed from its IZone the agent software could be designed to destroy all secure data and/or email. The IZone could be specified in BIOS. GPS could be checked by the BIOS upon boot to determine if computer can boot or not. The location tracking features also works worldwide since the GPS signal is free. Also, when next connected to the Internet, the computer will transmit its location obtained from the GPS receiver. This feature is highly attractive to high security customers (e.g., government) etc. Finally, the invention allows the replacement of software dongles, previously required/utilized to restrict access to certain software on the computer system.

It is important to note that while the present invention has been described in the context of a fully functional data processing system, those skilled in the art will appreciate that the mechanism of the present invention is capable of being distributed in the form of a computer readable medium of instructions in a variety of forms, and that the present invention applies equally, regardless of the particular type of signal bearing media utilized to actually carry out the distribution. Examples of computer readable media include: nonvolatile, hard-coded type media such as Read Only Memories (ROMs) or Erasable, Electrically Programmable Read Only Memories (EEPROMs), recordable type media such as floppy disks, hard disk drives and CD-ROMs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
identifying a current location of a computer system;
determining when said current location is one of a pre-approved location in which a software application is authorized to be installed on said computer system; and
when said current location is not a pre-approved location, preventing said software application from being installed on said computer system, wherein the software application is allowed to be installed only when said computer system is located in a pre-approved location.

2. The method of claim 1, further comprising:
detecting initiation of an installation process for said software application;
checking a pre-designated location field to determine whether the installation of the software application has location restrictions, prior to completing said determining.

3. The method of claim 2, wherein said location restrictions are computer system restrictions, and said determining comprises:
retrieving data indicating a current location of the computer system;
accessing a location approval list with a list of each location in which the installation of software on the computer system is approved; and
comparing the current location with the approved locations to find a match; and
enabling the installation to proceed when there is a match; and
when no match is found, blocking any further installation of the software application on said computer system within the current location.

4. The method of claim 3, wherein when said location restrictions are computer system restrictions for specific software applications, said blocking includes blocking installation of said specific software applications on said computer system within the current location.

5. The method of claim 2, wherein said location restrictions are software application restrictions, and said determining comprises:
retrieving data indicating a current location of the computer system;
accessing a location approval list, having a list of each location in which the installation of the software on the computer system is approved;
comparing the current location with the approved locations to find a match;
signaling when there is a match that installation may proceed; and
when no match is found, blocking installation of the software application within that current location.

6. The method of claim 5, wherein the accessing includes:
retrieving the list from a medium on which the software application code is stored, when said list is stored on the medium; and
retrieving the list from a source that is external to the medium, wherein an address of the source is provided within the installation sequence.

7. The method of claim 3, wherein when said software application includes a first component that is location restricted and second component, operationally independent of the first component and not location restricted, said preventing prevents only the location-restrictive component from being installed on the computer system, wherein only the second component is installed on the computer system.

8. The method of claim 3, wherein said retrieving comprises:
obtaining a GPS coordinate from a GPS receiver as said current location;
wherein said determining compares said GPS coordinate with a zone within which the installation maybe completed, such that said comparison results in a match when said GPS coordinate falls within the zone.

9. The method of claim 1, wherein said list of approved locations is stored on a network server, said determining further comprising:
generating a request for a comparison of the current location to the approved location list stored on the server, wherein the server address is provided within the installation sequence; and
accessing the network server to complete said comparing.

10. The method of claim 9, further comprising:
dynamically detecting a connection of said computer system to the Internet;
autonomically issuing the request to the server whenever the current location changes, wherein said software installation is scheduled and occurs at the time the computer system enters a zone within which the installation is approved; and
signaling that the installation has been successful.

11. The method of claim 1, wherein when said computer system with installed software application that is subject to location restrictions exits an approved zone, said method comprises:
initiating one or more protection mechanisms from among:
disabling the software application from being operational within the computer system;
automatically removing/deleting said software application from said computing device;
prompting for specific security parameters to enable access to the software application, wherein said access is provided only after verification of an entered authorization code; and
hiding the executables and signatures of the software application from a user of the computer system until said computer system reenters an approved location.

12. The method of claim 1, further comprising:
providing a security level within installation parameters that control a type of installation permitted for the software application within the approved locations, wherein said security level indicates what additional security features, if any, are required for the particular software application in the particular approved location, wherein a first level indicates that no additional security measures are required for installation and a second level indicates that pre-specified security measures are required for installation.

13. A computer program product comprising:
a computer readable medium;
program code on said computer readable medium for controlling installation of software application on the computer system, said program code comprising code for:
receiving from a location detecting mechanism data on a current location of a computer system within which said program code is being executed;
determining when said current location is one of a pre-approved location in which a software application is authorized to be installed on said computer system; and
when said current location is not a pre-approved location, preventing said software application from being installed on said computer system, wherein the software application is allowed to be installed only when said computer system is located in a pre-approved location.

14. The computer program product of claim 13, further comprising code for:
detecting initiation of an installation process for said software application;
checking a pre-designated location field to determine whether the installation of the software application has location restrictions, prior to completing said determining.

15. The computer program product of claim 14, wherein said location restrictions are computer system restrictions, and said code for determining comprises code for:
retrieving data indicating a current location of the computer system;
accessing a location approval list with a list of each location in which the installation of software on the computer system is approved; and
comparing the current location with the approved locations to find a match; and
enabling the installation to proceed when there is a match; and
when no match is found, blocking any further installation of the software application on said computer system within the current location.

16. The computer program product of claim 15, wherein when said location restrictions are computer system restrictions for specific software applications, said code for blocking includes code for blocking installation of said specific software applications on said computer system within the current location.

17. The computer program product of claim 14, wherein said location restrictions are software application restrictions, and said code for determining comprises code for:
retrieving data indicating a current location of the computer system;
accessing a location approval list, having a list of each location in which the installation of the software on the computer system is approved;
comparing the current location with the approved locations to find a match;
signaling when there is a match that installation may proceed; and
when no match is found, blocking installation of the software application within that current location.

18. The computer program product of claim 17, wherein the code for accessing includes code for:
retrieving the list from a medium on which the software application code is stored, when said list is stored on the medium; and
retrieving the list from a source that is external to the medium, wherein an address of the source is provided within the installation sequence.

19. The computer program product of claim 15, wherein when said software application includes a first component that is location restricted and second component, operationally independent of the first component and not location restricted, said code for preventing prevents only the location-restrictive component from being installed on the computer system, wherein only the second component is installed on the computer system.

20. The computer program product of claim 15, wherein said code for retrieving comprises code for:
obtaining a GPS coordinate from a GPS receiver as said current location;
wherein said code for determining compares said GPS coordinate with a zone within which the installation maybe completed, such that said comparison results in a match when said GPS coordinate falls within the zone.

21. The computer program product of claim 13, wherein said list of approved locations is stored on a network server, said code for determining further comprising code for:
generating a request for a comparison of the current location to the approved location list stored on the server, wherein the server address is provided within the installation sequence; and
accessing the network server to complete said comparing.

22. The computer program product of claim 19, further comprising code for:
dynamically detecting a connection of said computer system to the Internet;
autonomically issuing the request to the server whenever the current location changes, wherein said software installation is scheduled and occurs at the time the computer system enters a zone within which the installation is approved; and
signaling that the installation has been successful.

23. The computer program product of claim 13, wherein, when said computer system with installed software application that is subject to location restrictions exits an approved zone, said computer program product comprises code for:
initiating one or more protection mechanisms from among:
disabling the software application from being operational within the computer system;
automatically removing/deleting said software application from said computing device;
prompting for specific security parameters to enable access to the software application, wherein said access is provided only after verification of an entered authorization code; and
hiding the executables and signatures of the software application from a user of the computer system until said computer system reenters an approved location.

24. The computer program product of claim 13, further comprising code for:
providing a security level within installation parameters that control a type of installation permitted for the software application within the approved locations, wherein said security level indicates what additional security features, if any, are required for the particular software application in the particular approved location, wherein a first level indicates that no additional security measures are required for installation and a second level indicates that pre-specified security measures are required for installation.

25. A system for comprising:
a location detecting mechanism that identifies a current location of a computer system; and
a location approval utility that includes software means for:
identifying a current location of the computer system;
determining when said current location is one of a pre-approved location in which a software application is authorized to be installed on said computer system; and
when said current location is not a pre-approved location, preventing said software application from being installed on said computer system, wherein the software application is allowed to be installed only when said computer system is located in a pre-approved location.

26. The system of claim 25, wherein said location detection mechanism includes:
a GPS receiver that receives GPS coordinates of the current location of the computer system; and
a register for recording the current location of the computer system.

27. The system of claim 25, further comprising means for:
detecting initiation of an installation process for said software application;
checking a pre-designated location field to determine whether the installation of the software application has location restrictions, prior to completing said determining.

28. The system of claim 27, wherein said location restrictions are computer system restrictions, and said determining means comprises means for:
retrieving data indicating a current location of the computer system;
accessing a location approval list with a list of each location in which the installation of software on the computer system is approved; and
comparing the current location with the approved locations to find a match; and
enabling the installation to proceed when there is a match; and
when no match is found, blocking any further installation of the software application on said computer system within the current location.

29. The system of claim 28, wherein when said location restrictions are computer system restrictions for specific software applications, said means for blocking includes blocking installation of said specific software applications on said computer system within the current location.

30. The system of claim 27, wherein said location restrictions are software application restrictions, and said means for determining comprises means for:
retrieving data indicating a current location of the computer system;
accessing a location approval list, having a list of each location in which the installation of the software on the computer system is approved; and
comparing the current location with the approved locations to find a match; and
signaling when there is a match that installation may proceed; and
when no match is found, blocking installation of the software application within that current location.

31. The system of claim 30, wherein the means for accessing includes means for:
retrieving the list from a medium on which the software application code is stored, when said list is stored on the medium; and
retrieving the list from a source that is external to the medium, wherein an address of the source is provided within the installation sequence.

32. The system of claim 28, wherein when said software application includes a first component that is location restricted and second component, operationally independent of the first component and not location restricted, said means for preventing prevents only the location-restrictive component from being installed on the computer system, wherein only the second component is installed on the computer system.

33. The system of claim 28, wherein said means for retrieving comprises means for:
obtaining a GPS coordinate from a GPS receiver as said current location;
wherein said determining step compares said GPS coordinate with a zone within which the installation maybe completed, such that said comparison results in a match when said GPS coordinate falls within the zone.

34. The system of claim 25, wherein said list of approved locations is stored on a network server, said means for determining further comprising means for:
generating a request for a comparison of the current location to the approved location list stored on the server, wherein the server address is provided within the installation sequence; and
accessing the network server to complete said comparing.

35. The system of claim 34, further comprising means for:
dynamically detecting a connection of said computer system to the Internet;
autonomically issuing the request to the server whenever the current location changes, wherein said software installation is scheduled and occurs at the time the computer system enters a zone within which the installation is approved; and
signaling that the installation has been successful.

36. The system of claim 25, wherein when said computer system with installed software application that is subject to location restrictions exits an approved zone, said system comprises means for:
initiating one or more protection mechanisms from among:
disabling the software application from being operational within the computer system;
automatically removing/deleting said software application from said computing device;
prompting for specific security parameters to enable access to the software application, wherein said access is provided only after verification of an entered authorization code; and
hiding the executables and signatures of the software application from a user of the computer system until said computer system reenters an approved location.

37. The system of claim 25, further comprising means for:
providing a security level within installation parameters that control a type of installation permitted for the software application within the approved locations, wherein said security level indicates what additional security features, if any, are required for the particular software application in the particular approved location, wherein a first level indicates that no additional security measures are required for installation and a second level indicates that pre-specified security measures are required for installation.

38. A network system for preventing installation of software applications on computer systems outside of pre-specified approved locations, said network system comprising:
a computer system that includes a location device and a network connection device that enables the computer system to connect to a network;
a server that is accessible via the network and which maintains a list of approved locations within which software may be installed on the computer system;
a software utility executing on the computer system that provides software code for completing the following functions:
identifying a current location of the computer system from data received from said location device;
determining when said current location is one of a pre-approved location in which said software application is authorized to be installed on said computer system; and
when said current location is not a pre-approved location, preventing said software application from being installed on said computer system, wherein the software application is allowed to be installed only when said computer system is located in a pre-approved location; and
a response utility executing on the server that provides software code for completing the following functions:
receiving a request from the computer system to confirm whether a current location of the computer system is approved for installing software on the computer system;
comparing the current location from the request with approved locations within the list of approved locations; and
signaling the computer system a result of the comparison, wherein when the current location matches one of the approved locations, said computer system is sent an approval for installation of the software and when the current location does not match one of the approved locations, said computer system is sent a denial for installation of the software.

39. The network system of claim 38, wherein said location approval utility further comprises software code for:
detecting initiation of an installation process for said software application;
checking a pre-designated location field to determine whether the installation of the software application has location restrictions, prior to completing said determining;
retrieving data indicating a current location of the computer system;
generating a request for a comparison of the current location to the approved location list stored on the server, wherein the server address is provided within the installation sequence; and
accessing the network server to complete said comparing within the list of approved locations; and
receiving a result from the server indicating whether said location is an approved location;
enabling the installation to proceed when said location is an approved location; and
blocking any further installation of software application on said computer system within the current location when the current location is not an approved location.

40. The network system of claim 38, wherein:
said code for retrieving comprises code for obtaining a GPS coordinate from a GPS receiver as said current location; and
said code for determining initiates a comparison of said GPS coordinate with a zone within which the installation maybe completed, such that said comparison results in a match when said GPS coordinate falls within the zone.

41. The network system of claim 39, wherein said location approval utility further comprises code for:
dynamically detecting a connection of said computer system to the Internet; and
autonomically issuing the request to the server whenever the current location changes, wherein said software installation is scheduled and occurs at the time the computer system enters a zone within which the installation is approved.

42. The network system of claim 38, wherein the server further comprises code for responding to receipt of security level found within installation parameters that control a type of installation permitted for the software application within the approved locations, wherein said security level indicates what additional security features, if any, are required for the particular software application in the particular approved location, wherein a first level indicates that no additional security measures are required for installation and a second level indicates that pre-specified security measures are required for installation.
